(19) United States
(12) Patent Application Publication
(10) Pub. No.: US 2016/0283269 A1
(43) Pub. Date: Sep. 29, 2016

(54) TASK PROCESSING METHOD AND DEVICE FOR IMPLEMENTING MULTIPATH SEARCHING

(71) Applicant: ZHONGXING MICROELECTRONICS TECHNOLOGY CO. LTD, Shenzhen, Guangdong (CN)

(72) Inventors: Weicong XIE, Guangdong (CN); Haitao YANG, Guangdong (CN)

(21) Appl. No.: 15/035,981

(22) PCT Filed: May 19, 2014
(86) PCT No.: PCT/CN2014/077833

§ 371 Date: May 11, 2016

(30) Foreign Application Priority Data
Nov. 11, 2013 (CN) 201310558104.X

(51) Int. Cl. G06F 9/50; G06F 9/46; H04B 7/06

(52) U.S. Cl. CPC G06F 9/50; H04B 7/06; G06F 9/466

(57) ABSTRACT

Disclosed is a task processing method for realizing multipath searching, including: searching for a task information table at regular times to obtain tasks to be processed on each antenna, and ranking all the antennas according to occupied effective search resources; and according to the ranking, processing tasks to be processed on all the antennas. Also disclosed at the same time is a task processing device for realizing multipath searching.

### TECHNICAL FIELD

The present disclosure relates to the multipath searching technology in WCDMA (Wideband-Code Division Multiple Access), especially to a task processing method and device for implementing a multipath searching.

### BACKGROUND

In WCDMA system, a base station delivers received antenna data to a baseband module for processing. During this procedure, the processing of the baseband module has different processing delays depending on different channel coding schemes, circuit implementations, and task scheduling solutions. The antenna data is sent in real time. The base station should not miss the antenna data at any moment. Thereby, it is necessary to buffer the real-time antenna data into an antenna data caching module. In addition, unique caching enables modules, such as a multipath searching module and a multipath demodulation module, to share the antenna data via a bus, and supports the multipath searching and the multipath demodulation on various antenna data streams.

However, the multipath searching module needs to read the antenna data in the antenna data caching module in every searching period, thus mass of band widths are occupied, and the performance of the system is affected. Therefore, how to reduce the band width occupied by reading and writing the antenna data, and improve the performance of the system is an urgent and important problem.

### SUMMARY

In order to solve the existing technical problems, the embodiments of the present disclosure mainly provide a task processing method and device for implementing multipath searching.

The technical solutions of the present disclosure are implemented as follows.

The embodiments of the present disclosure provide a task processing method for implementing multipath searching, including: searching a task information table at regular time to obtain a task to be processed on each antenna, and ranking all the antennas depending on numbers of effective search resources occupied by the antennas; and processing the tasks to be processed on all the antennas according to the rank.

The embodiments of the present disclosure also provide a task processing device for implementing multipath searching, including: a task state machine control module and a task finding module, wherein

the task state machine control module is configured to achieve a state control to the task finding module, and

the task finding module is configured to search a task information table at regular time to obtain a task to be processed on each antenna, rank all the antennas depending on numbers of effective search resources occupied by the antennas, and process the tasks to be processed on all the antennas according to the rank.

The task processing method and device for implementing multipath searching provided by the embodiments of the present disclosure search the task information table at regular time to obtain the task to be processed on each antenna, rank all the antennas depending on the numbers of effective search resources occupied by the antennas, and process the tasks to be processed on all the antennas according to the rank. In this way, the frequency of requesting the antenna data can be greatly reduced, and each antenna only needs to be requested once, which efficiently decreases the occupied band width of the bus, and improves the performance of the system. In particular, on average, assuming that X tasks are evenly distributed on Y antennas, then by adopting the method of the embodiments of the present disclosure, the antenna data only needs to be requested for Y times, and compared with the practice in the related art in which the antenna data needs to be requested according to tasks, the band width occupied by the method of the embodiments in the present disclosure is only Y/X of that in the method in the related art. In a most extreme case, assuming that X tasks are concentrated on one antenna, then the band width occupied in the embodiments of the present disclosure is only 1/X of that in the method of the related art.

### BRIEF DESCRIPTION OF THE DRAWINGS

FIG. 1 is a flowchart of a task processing method for implementing multipath searching according to an embodiment of the present disclosure;

FIG. 2 is a flowchart of another task processing method for implementing multipath searching according to an embodiment of the present disclosure; and

FIG. 3 is a structural schematic diagram of a task processing device for implementing multipath searching according to an embodiment of the present disclosure.

### DETAILED DESCRIPTION

In embodiments of the present disclosure, a task information table is searched at regular time to obtain a task to be processed on each antenna, all the antenna are ranked depending on numbers of effective search resources occupied by the antennas, and then the tasks to be processed on all the antenna are processed according to the rank.

Before searching the task information table at regular time, the embodiments of the present disclosure further include: reading a task request at regular time, and updating a task parameter in the task information table.

Correspondingly, searching the task information table at regular time is implemented by searching the updated task information table at regular time.

Hereinafter, further detailed explanations are given in combination with drawings and specific embodiments.

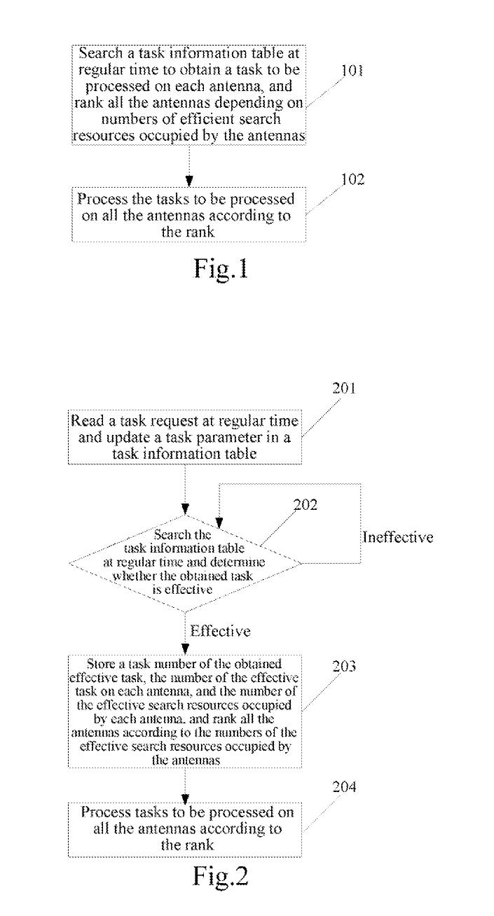

FIG. 1 is a flowchart of a task processing method for implementing multipath searching according to an embodiment of the present disclosure. As shown in FIG. 1, the flow of the task processing method for implementing multipath searching includes the following steps.

In step 101, a task information table is searched at a regular time interval to obtain a task to be processed on each antenna, and all the antenna are ranked depending on numbers of effective search resources occupied by the antennas.

Herein, before searching the task information table at regular time, the method further includes: reading a task request at regular time, and updating a task parameter in the task information table.

The reading the task request at regular time, and updating the task parameter in the task information table includes:

reading a task request in each slot (1 frame=15 slots=38400 chips) based on a system timing, reading a task parameter of an address corresponding to a task number carried in the task request, and updating the read task parameter into the task information table corresponding to the task number.

Generally, a configuration cycle of the task request is one slot, which is divided into two portions: preceding M chips and later N chips. Values of M and N may be set automatically according to actual conditions. The preceding M chips are for issuing time of the task request, and the later N chips are for reading time of the task request, wherein the issuing time of the task request is prior to the reading time of the task request.

The task parameter includes an antenna number, a width of search window, a scrambling, and the like.

The task information table uses the task number as an address index. The task information table saves task states therein, i.e., whether the task is effective or whether an effective time of the task has started.

Accordingly, the searching the task information table at regular time includes:

starting the search to the task information table in the beginning of each slot, searching and reading the updated task information table according to the task number sequentially, and writing the task number of the read effective task into a corresponding antenna linked list according to an antenna number included in the task parameter read from the task information table, until the search to the entire task information table is completed, in this way, the antenna linked lists of different antenna numbers, a sum of tasks to be processed on different antennas, and a sum of effective search resources occupied by each antenna would be obtained.

The antenna linked list stores the task number of an effective task previous to the effective task of the current task number in this slot of this antenna by using the task number as an index.

In step 102, tasks to be processed on all the antennas are processed according to the rank.

Herein, processing tasks to be processed on all the antennas according to the rank is specifically implemented by:

reading an antenna number of an antenna which occupies the most effective search resources according to the rank of the numbers of the effective search resources occupied by all the antennas, reading a last effective task number on the antenna according to the antenna number, reading a task parameter of a corresponding address in the task information table according to the effective task number, writing the task into a task running storage area, and reading a previous effective task number on the antenna, until all the effective tasks on this antenna are written into the task running storage area, and the process to the antenna tasks is completed; and then processing the antenna which occupies the second most effective search resources; and so on, till all the antennas are processed.

FIG. 2 is a flowchart of another task processing method for implementing multipath searching according to an embodiment of the present disclosure. As shown in FIG. 2, the flow of the task processing method for implementing multipath searching includes the following steps.

In step 201, a task request is read at regular time and a task parameter in a task information table is updated.

Herein, reading the task request at regular time and updating the task parameter in the task information table includes:

reading a task request in each slot (1 frame=15 slots=38400 chips) based on a system timing, reading a task parameter of an address corresponding to a task number carried in the task request, and updating the read task parameter into the task information table corresponding to the task number.

Generally, a configuration cycle of the task request is one slot, which is divided into two portions: preceding M chips and later N chips. Values of M and N may be set automatically according to actual conditions. The preceding M chips are for issuing time of the task request, and the later N chips are for reading time of the task request, wherein the issuing time of the task request is prior to the reading time of the task request.

The task parameter includes an antenna number, a width of search window, a scrambling, and the like.

In step 202, the task information table is searched at regular time and whether the obtained task is effective is determined; if the task is effective, step 203 is performed; and if the task is ineffective, step 202 is continued to be performed.

Herein, searching the task information table at regular time and determining whether the obtained task is effective includes: starting the search to the updated task information table in the beginning of each slot, searching the task information table according to the task number sequentially, and determining whether the obtained task is effective based on a task state saved in the task information table.

In step 203, a task number of the obtained effective task, the number of the effective tasks on each antenna, and the number of the effective search resources occupied by each antenna are stored, and all the antennas are ranked according to the numbers of the effective search resources occupied by the antennas.

Herein, the task information table uses the task number as an address index, and the task information table also stores the task state therein, i.e., whether the task is effective or whether an effective time of the task has started.

Accordingly, searching the task information table at regular time includes:

starting the search to the updated task information table in the beginning of each slot, searching and reading the task information table according to the task number sequentially, and writing the task number of the read effective task into a corresponding antenna linked list according to an antenna number included in the task parameter read from the task information table, until the search to the entire task information table is completed, in this way, the antenna linked lists of different antenna numbers, a sum of tasks to be processed on different antennas, and a sum of effective search resources occupied by each antenna would be obtained.

The antenna linked list stores the task number of an effective task previous to the effective task of the current task number in this slot of this antenna by using the task number as an index.

In step 204, tasks to be processed on all the antennas are processed according to the rank.

Herein, processing tasks to be processed on all the antennas according to the rank includes:

reading an antenna number of an antenna which occupies the most effective search resources according to the rank of the numbers of the effective search resources occupied by all the antennas, reading a last effective task number on the antenna according to the antenna number, reading a task parameter of a corresponding address in the task information table according to the effective task number, writing the task into a task running storage area, and reading a previous effective task number on the antenna, until all the effective tasks on the antenna are written into the task running storage area, and the process to the antenna task is completed, and so on; and then processing the antenna which occupies the second most effective search resources, till all the antennas are processed.

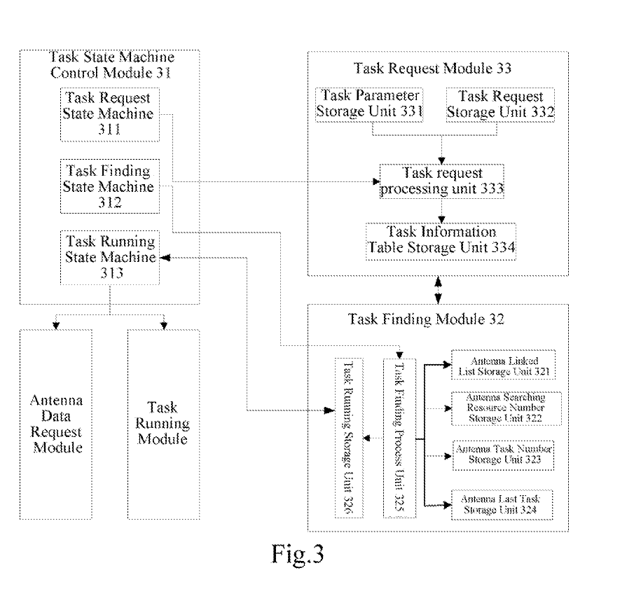

FIG. 3 is a structural schematic diagram of a task processing device for implementing multipath searching according to an embodiment of the present disclosure. For sake of explanation, in addition to the task processing device, two modules, i.e., an antenna data requesting module and a task running module, are added in FIG. 3, for assisting explanations of functions of each module in the task processing device.

As shown in FIG. 3, the task processing device for implementing multipath searching according to an embodiment of the present disclosure includes: a task state machine control module 31 and a task finding module 32.

The task state machine control module 31 may be a state controller configured to achieve a state control to the task finding module 32.

The task finding module 32 may be a combination of a processor and a memory, and configured to search a task information table at regular time to obtain a task to be processed on each antenna, rank numbers of effective searching resources occupied by all the antenna, and process the tasks to be processed on all the antenna according to the rank.

Preferably, the device further includes: a task request module 33 configured to read the task request at regular time and update a task parameter in the task information table.

Preferably, the task state machine control module 31 is further configured to achieve a state control to the task request module 33 and a state control to the task running.

Preferably, the task state machine control module 31 includes: a task request state machine 311, a task finding state machine 312, and a task running state machine 313. Respective state machines control the processing procedure of task requesting, the task searching and the task running in parallel.

The task request state machine 311 is configured to achieve a state control to the task request in the task request module 33.

The task finding state machine 312 is configured to achieve a state control to the task finding in the task finding module 32.

The task running state machine 313 is configured to achieve a state control to the task running.

In particular, the state control to the task running is as follows: reading a task parameter of an effective task on different antennas from the task running storage unit 326, requesting antenna data and issuing a task per antennas according to a rank of the numbers of occupied searching resources.

Preferably, the task finding module 32 includes: an antenna linked list storage unit 321, an antenna searching resource storage unit 322, an antenna task number storage unit 323, an antenna last task storage unit 324, a task running storage unit 326, and a task finding process unit 325.

The antenna linked list storage unit 321 is configured to store an antenna linked table of each antenna by using a task number as an address index.

The antenna searching resource storage unit 322 is configured to store the number of effective search resources occupied by each antenna by using an antenna number as an index.

The antenna task number storage unit 323 is configured to store the number of effective tasks on each antenna by using an antenna number as an index.

The antenna last task storage unit 324 is configured to store a task number of a last effective task on each antenna by using an antenna number as an index.

The task finding process unit 325 is configured to search the task information table to obtain a task to be processed on each antenna, rank the numbers of effective search resources occupied by all the antennas, and process the task to be processed on all the antennas according to the rank under the control of the task finding state machine.

The task running storage unit 326 is configured to store the task of each antenna.

Herein, the task information table saves the task state, i.e., whether the task is effective or whether the effective time of the task has been started, by using the task number as an address index.

The antenna linked list stores the task number of an effective task previous to the effective task of the current task number in this slot of this antenna by using the task number as an index.

In actual applications, the antenna searching resource storage unit 322 may be an antenna searching resource register set, the antenna task number storage unit 323 may be an antenna task number register set, and the antenna last task storage unit 324 may be an antenna last task register set.

Preferably, the task request module 33 includes: a task parameter storage unit 331, a task request storage unit 332, a task information table storage unit 334, and a task request processing unit 333.

The task parameter storage unit 331 is configured to store the task parameter.

The task request storage unit 332 is configured to store the task request, is generally an interface with the software, and is implemented by First Input First Output (FIFO).

The task information table storage unit 334 is configured to store the task information table.

The task request processing unit 333 is configured to read the task request and update the task parameters in the task information table under the control of the task request state machine 311.

Herein, the task parameter includes: an antenna number, a width of searching window, a scramble, and the like.

The above-mentioned contents are only the preferred embodiments of the present disclosure, and do not intend to limit the protection scope of the present disclosure.

1. A task processing method for implementing multipath searching with respect to a plurality of antennas, comprising:
searching a task information table at regular time to obtain a task to be processed on each antenna, and ranking all the antennas depending on numbers of effective search resources occupied by the antennas; and
processing the tasks to be processed on all the antennas according to the rank.

2. The method of claim 1, wherein before searching the task information table at regular time, the method further comprises: reading a task request at a regular time interval, and updating a task parameter in the task information table.

3. The method of claim 2, wherein the reading the task request at the regular time interval and updating the task parameter in the task information table comprises:
reading a task request in each slot, reading a task parameter of an address corresponding to a task number carried in the task request, and updating the task information table corresponding to the task number by the task parameter.

4. The method of claim 3, wherein the searching the task information table at the regular time interval comprises:
starting searching the task information table at the beginning of each slot, searching and reading the updated task information table according to the task number sequentially,
writing the task number of a read effective task into a corresponding antenna linked list according to an antenna number included in the task parameter read from the task information table, until the search to the entire task information table is completed, so as to obtain the antenna linked lists of different antenna numbers, a sum of tasks to be processed on different antennas, and a sum of effective search resources occupied by each antenna.

5. The method of claim 4, wherein the processing the tasks to be processed on all the antennas according to the rank is implemented by:
reading an antenna number of an antenna which occupies the maximum effective search resources according to the rank of the numbers of the effective search resources occupied by all the antennas, reading a last effective task number on the antenna according to the antenna number, reading a task parameter of a corresponding address in the task information table according to the effective task number, and writing the task into a task running storage area;
reading a previous effective task number on the antenna, until all the effective tasks on the antenna are written into the task running storage area to complete processing the antenna task;
processing the antenna which occupies the second maximum effective search resources; and
repeating the foregoing steps till all the antennas are processed.

6. A task processing device for implementing multipath searching with respect to a plurality of antennas, comprising: a task state machine control module and a task finding module, wherein
the task state machine control module is configured to achieve a state control to the task finding module; and
the task finding module is configured to search a task information table at a regular time interval to obtain a task to be processed on each antenna, rank numbers of effective searching resources occupied by all the antenna, and process the tasks to be processed on all the antenna according to the rank.

7. The device of claim 6, further comprising:
a task request module configured to read a task request at the regular time interval, and update a task parameter in the task information table.

8. The device of claim 7, wherein the task state machine control module is further configured to achieve a state control to the task request module and a state control to a task running.

9. The device of claim 8, wherein the task state machine control module comprises: a task request state machine, a task finding state machine, and a task running state machine, wherein
the task request state machine is configured to achieve a state control to the task request in the task request module;
the task finding state machine is configured to achieve a state control to a task finding in the task finding module; and
the task running state machine is configured to achieve a state control to the task running.

10. The device of claim 8, wherein the task request module comprises: a task parameter storage unit, a task request storage unit, a task information table storage unit, and a task request processing unit, wherein
the task parameter storage unit is configured to store the task parameter;
the task request storage unit is configured to store the task request;
the task information table storage unit is configured to store the task information table; and
the task request processing unit is configured to read the task request at the regular time interval and update the task parameters in the task information table under the control of the task request state machine.

11. The device of claim 8, wherein the task finding module comprises: an antenna linked list storage unit, an antenna searching resource number storage unit, an antenna task number storage unit, an antenna last task storage unit, a task running storage unit, and a task finding process unit, wherein
the antenna linked list storage unit is configured to store an antenna linked table of each antenna;
the antenna searching resource number storage unit is configured to store the number of effective search resources occupied by each antenna;
the antenna task number storage unit is configured to store the number of effective tasks on each antenna;
the antenna last task storage unit is configured to store a task number of a last effective task on each antenna; and
the task finding process unit is configured to, under the control of the task finding state machine, search the task information table to obtain a task to be processed on each antenna, rank the numbers of effective search resources occupied by all the antenna, and process the task to be processed on all the antenna according to the rank.

12. A non-transitory computer-readable storage medium storing instructions which, when executed by a processor, cause the processor to perform a task processing method for implementing multipath searching with respect to a plurality of antennas, the method comprising:
searching a task information table at a regular time interval to obtain a task to be processed on each antenna, and ranking all the antennas depending on numbers of effective search resources occupied by the antennas; and
processing the tasks to be processed on all the antennas according to the rank.
